(19) United States
(12) Patent Application Publication
(10) Pub. No.: US 2009/0218172 A1
(43) Pub. Date: Sep. 3, 2009

(54) E-Z shim machine

(76) Inventor: Ezra Shimshi, Atlanta, GA (US)

Correspondence Address: EZRA SHIMSHI, P.O. BOX 421011, ATLANTA, GA, 30342, US

(21) Appl. No.: 12/074,147

(22) Filed: Feb. 29, 2008

(51) Int. Cl. F03G 1/08

(52) U.S. Cl. 185/39

(57) ABSTRACT

My invention makes it easy to force units of mass to jump-up along a vertical line by means of seesaw-like frames, central stationary gear, planetary gears, springs, cylinders and pistons, blockers, triggers, cables, pulleys and cable's slack takers, in order to create imbalance on the same side of the frames that propels the frames to rotate continuously in the same direction and, thus, provide usable rotational energy.

### BACKGROUND OF THE INVENTION

a) Field Of The Invention

The present invention relates to machines, systems and methods through which electricity is generated, by creating controlled imbalance on seesaw-like frames that propels the frames into unidirectional rotation.

b) The Prior Art

There are no machines, systems, or methods known through which electricity is generated with the easiness of assembly and simplicity of components as in this instant invention.

### SUMMARY OF THE INVENTION

The present invention makes it easy to build machines that have simple parts such as rotating seesaw-like frame, units of mass, set of gears, springs, or springs and cylinders and pistons, blockers, triggers, cables, pulleys and cable's slack takers—all designed to create imbalance at the same side of the rotating frame, in order to propel the frame into continued rotation in the same direction that produces useable rotational energy.

### BRIEF DESCRIPTION OF THE DRAWINGS

The present invention will be more readily understood by reference to the following description, taken with the accompanying drawings, in which:

FIG. 1 shows a single frame 5, vertically positioned, parallel to vertical wall 11. Both cylindrical sliders 6 and their respective magnet rings 6′ are seen blocked by their respective blockers 16 at their highest points at their respective guiders 15. The central stationary gear 8 is depicted as being fixed to vertical wall 11.

FIG. 2 shows the same frame 5 as in FIG. 1, but after rotating 180 degrees. The upper and lower cylindrical sliders 6 are seen unblocked and are free to jump-up along their respective guiders 15.

FIG. 3 shows the same frame 5 as in FIG. 1, but with pistons 6″ blocked by their respective blockers 16 at their highest points in their respective cylinders 15′, which are fixed to Frame 5.

FIG. 4 shows the same frame 5 as in FIG. 3, but after rotating 180 degrees. The upper and lower pistons 6″ are seen unblocked and are free to jump-up along their respective cylinders 15′. The upper piston 6″ is being pulled by the upper spring 12 and the lower piston 6″ is pulled by vacuum 12′ and pushed by the atmospheric pressure.

### DESCRIPTION OF THE EMBODIMENT

Parts in the embodiment and its designated numbers in the drawings are:

Frame 5; [Cylindrical sliders 6; Magnet rings 6′; Disks 7]; or Piston 6″; Central stationary gear 8; Largest gears 9; Combination gears 10; Smallest gears 10′; Vertical wall 11; Springs 12; [or Springs 12 and Vacuum 12′ and Vents 12″]; Pulleys 13; Cables 14; Guiders 15; [or cylinders 15′]; Blockers 16; Triggers 16′; Cable's slack takers 17.

The invention may be implemented in a wide range of embodiments.

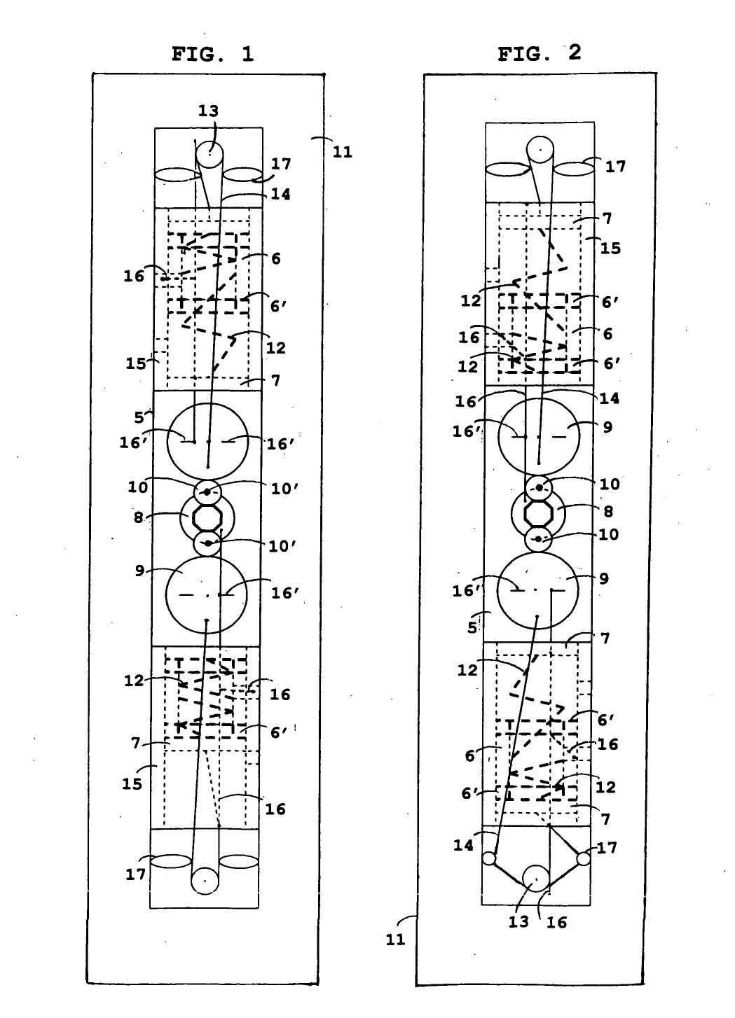

FIG. 1 shows both cylindrical sliders 6 and their attached magnet rings 6′ at their highest points on their respective guiders 15. Guiders 15 are fixed to frame 5. As the seesaw-like frame 5, which is positioned vertically, rotates clockwise 180 degrees to its next vertical position, the largest gears 9 rotate counterclockwise 180 degrees by revolving around the central stationary gear 8 by means of their respective combination gears 10. The 180 degrees rotation by frame 5 causes the descending cable 14, which connects the descending largest gear 9 with the descending outer spring 12, by means of the descending pulley 13 and the descending outer disk 7, to slacken. Cable's slack takers 17 take this slack, as seen in FIG. 2. This cable' slack 17 allows the descended cylindrical slider 6, with its attached magnet rings 6′ and with the descended outer disk, to jump-up along the descended guider 15, when it unblocked by the descended blocker 16 through the respective descended trigger 16′. After this jump, the two descended springs 12 became boxed-in by the descended cylindrical slider 6, the descended magnet rings 6′ and the descended disks 7, at their highest point on the descended guider 15, shown in FIG. 1. At that high point on the descended guider 15, the descended blocker 16 blocks the descended cylindrical slider 6. Triggers 16′ are fixed on their respective large gears 9 and blockers 16 are held by their respective disks 7, through which they are adapted to slide. During ascendence, the ascending outer disk 7 is being pulled away from the respective ascending magnet ring 6′ and from the blocked ascending cylindrical slider 6 by the ascending cable 14. The ascending outer disk 7, in turn, pulls with it the outer ascending spring 12, which is fixed to the ascending outer disk 7 at one end and to the ascending blocked cylindrical slider 6 at the other end. The ascending outer spring 12 is being stretched until the ascending blocked cylindrical slider 6 completes its ascendance. At that point, the ascended outer spring 12 is in its full tension, as seen in FIG. 2, and the ascended cylindrical slider 6 is unblocked by means of the respective ascended trigger 16′, which is fixed on the ascended largest gear 9, setting it free to jumps-up along the ascended guider 15. At that moment, transfer of tension occurs from the ascended outer spring 12, which has higher degree of tension, to the ascended inner spring 12, which is fixed between the ascended inner disk 7 and the ascended cylindrical slider 6, and which has only enough tension to lift one cylindrical slider 6, its attached magnet rings 6′ and its outer disk 7, when at their descended position. The ascended cylindrical slider 6 is blocked with its ascended magnet rings 6′, the ascended outer disk 7 and the ascended outer spring 12 by the ascended blocker 16, at their highest point, as seen in FIG. 1. Both inner disks 7 are fixed in the same positions, but the outer disks 7 are adapted to slide, like cylindrical sliders 6 and magnet rings 6′, along their respective guiders 15. The repeated jumps by cylindrical sliders 6, after each 180 degrees rotation, shift the center of mass toward the same side of the rotating frame 5. This shift of the center of mass creates the desired imbalance that produces continuation of rotation, by frame 5, in the same direction. To achieve constant rate of rotation, similar frames 5 and components can be added to rotate in unison.

The capacity of the tension of the ascended outer sprig 12 to lift the ascended cylindrical slider 6 and the ascended magnet rings 6′ and also to transfer tension to the ascended inner spring 12, as well as the capacity of the tension of the descended inner spring 12 to lift the descended cylindrical slider 6, the descended magnet rings 6′ and the descended outer disk 7, are the upshot of the capability of the present machine to create tension in each spring 12 with a unit of mass, which is lighter than the actual unit of mass that is needed to create such tension. The added force of magnet rings 6′ is essential in order to equalize, in predetermined degree, the force needed to stretch each spring so that each tension can be built-up with the same force, more or less, during the stretching of each spring 12 and, thus, enabling also more perfect transfer of tension from the ascended outer spring 12 to the ascended inner spring 12.

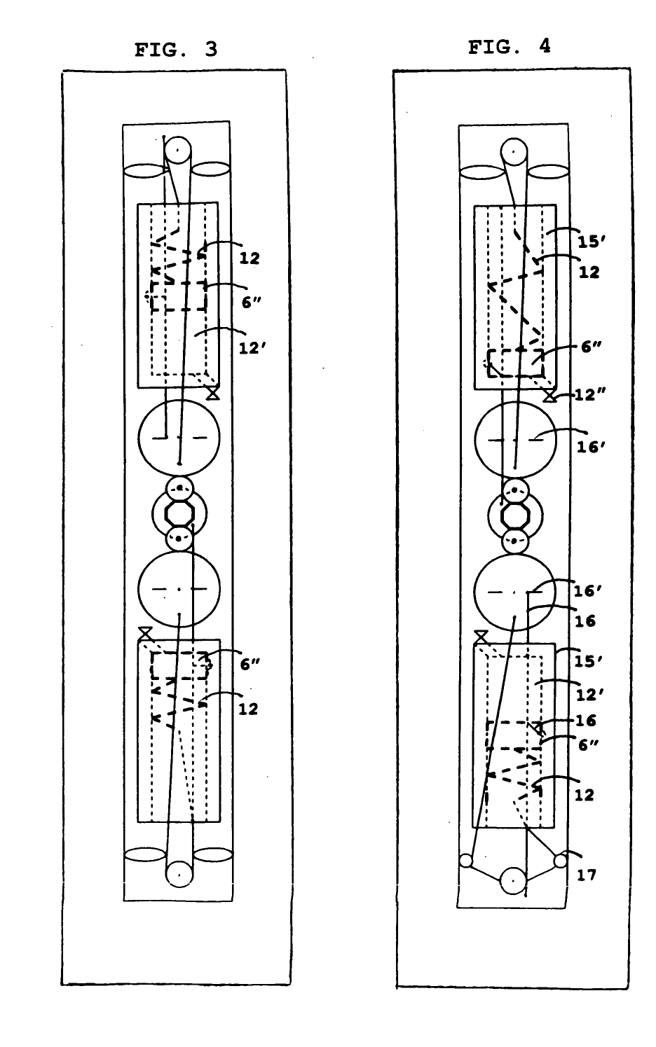

Springs 12 may be substituted by other means that can be made to have the capacity to pull or push a unit of mass so as to create the desired one-sided imbalance in a seesaw-like frame in order to propel the frame into a continued unidirectional rotation. FIG. 3 and FIG. 4 show how the inner springs 12, guiders 15, cylindrical sliders 6, magnet rings 6′ and disks 7 are replaced with cylinder 15′ and piston 6″. The role of vacuum 12′ is equivalent to the role of the inner spring 12.

The central stationary gear 8, the combination gears 10, that includes the smallest gears 10′, and the largest gears 9, are the means by which each spring 12 can be stretch, or vacuum 12′ can be created, with lighter unit of mass than the unit of mass that is actually needed to stretch each of such springs 12, or each of vacuum 12′. Vent 12″ is designed to maintain the highest vacuum capacity by releasing any air leakage each cycle. The central stationary gear 8 has the same number of teeth as in each of the largest gears 9. Moreover, each combination gear 10, which includes smallest gear 10′ that mesh with the central stationary gear 8, has the same number of teeth as the other set of teeth in the combination gear 10 and it mesh with the respective largest gear 9.

While this invention has been described with reference to the mechanism disclosed herein, it is not confined to the details as set forth and is not intended in any way to limit the broad features or principles of the present machine, system and method, or the scope of patent monopoly to be granted. This application is intended to cover any modification or changes that may come within the scope of the following claims.

I claim as my invention:

1. Apparatus, for moving the center of mass during rotation of a seesaw-like frame so as to create imbalance on the same side of the frame in order to propel the frame in the same direction and at the desired constant rate when combined to rotate in unison with additional identical frames and components, comprising:
(a) Frames;
(b) Units of mass;
(c) Springs;
(d) Blockers;
(e) Means for creating predetermined tension in each of the respective springs during the frames rotation in order to produce one-sided imbalance that propels the frames to rotate continuously in the same direction.

2. The apparatus as in claim 1, wherein the means for creating predetermined tension in each of the respective springs during the frames rotation in order to produce one-sided imbalance that propels the frames to rotate continuously in the same direction, comprising:
(a) Central stationary gear;
(b) Sets of planetary gears, each adapted to revolve around the central stationary gear and is designed so as to have the capacity to build tension in each of the springs with a unit of mass that is lighter than the unit of mass, which is actually needed to build such tension.

3. A method, by which a frame can be propelled so as to continuously rotate in the same direction, including the steps:
(a) Arranging sets of planetary gears to revolve around central stationary gear, designed to create pulling forces, each pulling force capable of lifting a unit of mass that is lighter than the unit of mass needed to create said pulling force;
(b) Creating the respective pulling forces by means of central stationary gear and planetary gears so as to force the units of mass to jump-up when they are realigned on a vertical line and, then, having them blocked in their highest positions;
(c) Unblocking the units of mass when they realign on a vertical line, after completing 180 degrees rotation, so as to set them free to jump-up along the vertical line and, then, having the units of mass blocked again at their highest positions.

4. A system, for producing usable rotational energy by moving the center of mass, in a rotating system, toward the same side of the system in order to create one-sided imbalance that propels the system into continued rotation in the same direction, comprising:
(a) Units of mass;
(b) Set of gears, designed to have the capacity to force the units of mass to move toward the same side of the system every 180 degrees rotation;
(c) Means for utilizing the capacity of the set of gears to force the units of mass to move toward the same side of the system every 180 degrees rotation.

5. The system as in claim 4, wherein the means for utilizing the capacity of the set of gears to force the units of mass to move toward the same side of the system every 180 degrees rotation, comprising:
(a) Springs;
(b) Cylinders;
(c) Pistons;
(d) Blockers.
